(19) United States
(12) Patent Application Publication
(10) Pub. No.: US 2021/0141194 A1
(43) Pub. Date: May 13, 2021

(54) OPTICAL IMAGING LENS SYSTEM

(71) Applicant: ACE SOLUTECH CO., LTD., Seongnam-si, Gyeonggi-do (KR)

(72) Inventors: Pil Sun JUNG, Gyeonggi-do (KR); Dong Young KIM, Gyeonggi-do (KR); Chi Ho AN, Gyeonggi-do (KR)

(21) Appl. No.: 16/086,246

(22) PCT Filed: Mar. 16, 2017
(86) PCT No.: PCT/KR2017/002833

§ 371 Date: Aug. 12, 2020

(30) Foreign Application Priority Data
Mar. 18, 2016 (KR) 10-2016-0032937

(51) Int. Cl. G02B 13/00; G02B 9/62

(52) U.S. Cl. CPC G02B 13/0045; G02B 9/62

(57) ABSTRACT

Provided is a lens optical system. The lens optical system includes a first lens, a second lens, a third lens, a fourth lens, a fifth lens, and a sixth lens sequentially arranged in the stated order between an object and an image sensor. The first lens, the third lens, and the fifth lens have a positive (+) power, and the second lens, the fourth lens, and the sixth lens have a negative (−) power.

### CROSS REFERENCE TO RELATED APPLICATIONS

This application is the National Stage of International Application No. PCT/KR2017/002833, having an International Filing Date of 16 Mar. 2017, which designated the United States of America, and which International Application was published under PCT Article 21(2) as WO Publication No. 2017/160093 A1, which claims priority from and the benefit of Korean Patent Application No. 10-2016-0032937, filed on 18 Mar. 2016, the disclosures of which are incorporated herein by reference in their entireties.

### BACKGROUND

### 1. Field

The present disclosure relates to an optical apparatus, and more particularly, to a miniature lens optical system applied to an imaging apparatus.

### 2. Description of Related Art

The use of semiconductor image sensors is expanding to a variety of applications that require image capturing, such as industrial, domestic, and recreational fields.

The performance of semiconductor image sensors such as a charge-coupled device (CCD) and a complementary metal oxide semiconductor (CMOS) has greatly improved, and thus, semiconductor image sensors are being widely applied to various fields. Since semiconductor image sensors are continually being innovated and their pixel density is being rapidly increased, they may be used to capture ultra-high-resolution images that are small in size.

For such high-resolution image sensors, corresponding high-quality lens optical systems are required. High-quality optical systems, particularly super-wide-angle optical systems, may need to have small aberrations and also high sharpness in all regions.

In order to obtain high-quality images, not only such high-quality imaging devices but also corresponding lens optical systems may be required.

Recently, imaging devices, that is, image sensors, are installed as a necessity in general compact cameras, for example, in mobile phones, and are rapidly becoming ultra-high in terms of resolution. Accordingly, compact and high-quality lens optical systems may be required to ensure the performance of such ultra-high-resolution image sensors.

As such, there is still a need for research on lenses having optical performance higher than that required for compact cameras while being easy to mold and process and easy to miniaturize, and which may reduce manufacturing costs.

### SUMMARY

Provided is a lens optical system that is compact and may be used in an ultra-high-resolution imaging apparatus.

Also provided is a lens optical system that may be easily miniaturized and may reduce manufacturing costs while having high optical performance.

According to an aspect of the present disclosure, a lens optical system includes:

a lens system including a first lens, a second lens, a third lens, a fourth lens, a fifth lens, and a sixth lens that are sequentially arranged in the stated order on an optical axis between an object and an image plane, wherein each of the first to sixth lenses has an incidence surface facing the object and an exit surface facing the image plane,

the first lens having a positive power,

the second lens having a negative power,

the third lens having a positive power,

the fourth lens having a negative power,

the fifth lens having a positive power,

the sixth lens having a negative power,

and satisfies at least one of the following Conditions 1 to 6:

70≤FOV≤90 <Condition 1>

where FOV (Field of view) denotes an angle of view of the lens optical system in a diagonal direction.

0.55≤TTL/IH≤0.8 <Condition 2>

where TTL (Total Track Length) denotes a height from the first lens to the image plane and IH (Image Height) denotes an image height in an effective diameter.

0.9≤Ind1/Ind2≤1.05 <Condition 3>

where Ind2 denotes a refractive index of the second lens and Ind1 denotes a refractive index of the first lens.

1.5≤Abv1/Abv2≤3.5 <Condition 4>

where Abv1 denotes an Abbe number of the first lens and Abv2 denotes an Abbe number of the second lens.

0.9≤Ind6/Ind4≤1.05 Condition 5>

where Ind6 denotes a refractive index of the sixth lens and Ind4 denotes a refractive index of the fourth lens.

1.5≤Abv6/Abv4≤3.5 <Condition 6>

where Abv6 denotes an Abbe number of the sixth lens and Abv4 denotes an Abbe number of the fourth lens.

According to an embodiment of the present disclosure, an iris diaphragm (stop) may be provided between the incidence surface and the exit surface of the first lens in the lens optical system.

According to an embodiment of the present disclosure,

at least one of the first to sixth lenses may have an aspherical incidence surface or exit surface.

It may be possible to implement a wide-angle lens optical system that is compact and may achieve high performance/high resolution. More particularly, a lens optical system according to an embodiment of the present disclosure may include a first lens, a second lens, a third lens, a fourth lens, a fifth lens, and a sixth lens that are sequentially arranged in the stated order between an object and an image sensor and respectively have a positive (+) power, a negative (−) power, a positive (+) power, a negative (−) power, a positive (+) power, and a negative (−) power, and may include an iris diaphragm (stop) arranged between an incidence surface and an exit surface of the first lens or may satisfy at least one of the Conditions 1 to 6. As a wide-angle optical apparatus, the lens optical system may be suitable for an ultra-high-resolution photographing apparatus as well as a general photographing apparatus.

### BRIEF DESCRIPTION OF DRAWINGS

FIG. 1 is a cross-sectional view illustrating the arrangement of main components of a lens optical system according to a first embodiment of the present disclosure.

FIG. 2 is a cross-sectional view illustrating the arrangement of main components of a lens optical system according to a second embodiment of the present disclosure.

FIG. 3 is a cross-sectional view illustrating the arrangement of main components of a lens optical system according to a third embodiment of the present disclosure.

FIG. 4 is an aberration diagram illustrating longitudinal spherical aberration, astigmatic field curvature, and distortion of the lens optical system according to the first embodiment of the present disclosure.

FIG. 5 is an aberration diagram illustrating longitudinal spherical aberration, astigmatic field curvature, and distortion of the lens optical system according to the second embodiment of the present disclosure.

FIG. 6 is an aberration diagram illustrating longitudinal spherical aberration, astigmatic field curvature, and distortion of the lens optical system according to the third embodiment of the present disclosure.

### DETAILED DESCRIPTION

Hereinafter, lens optical systems according to embodiments of the present disclosure will be described in detail with reference to the accompanying drawings Like reference numerals will denote like elements throughout the specification.

FIGS. 1 to 3 illustrate lens optical systems according to first to third embodiments of the present disclosure, respectively.

As illustrated in FIGS. 1 to 3, the lens optical system according to embodiments of the present disclosure may include six groups of six lenses and may include six lenses that are sequentially arranged from a subject or an object OBJ to an image forming plane (image plane) or an image sensor IMG where an image of the object OBJ is formed.

As described below, and incidence surface may refer to a surface facing an object and an exit surface may refer to a surface facing an image sensor.

The six lenses may have an incidence surface where light is incident, that is, an incidence surface facing the object OBJ, and an exit surface where light exits, that is, an exit surface facing the image sensor IMG, and may include a first lens I, a second lens II, a third lens III, a fourth lens IV, a fifth lens V, and a sixth lens VI.

The first lens I may have a positive (+) power (refractive index). According to an embodiment of the present disclosure, the first lens I may have an incidence surface convex toward the object OBJ.

The second lens II may have a negative (−) power, and according to an embodiment of the present disclosure, the second lens II may have a meniscus shape convex toward the object OBJ.

The third lens III may have a positive (+) power, and according to an embodiment of the present disclosure, the third lens III may be a biconvex lens.

The fourth lens IV may have a negative (−) power, and according to an embodiment of the present disclosure, the fourth lens IV may be a meniscus lens having an incidence surface and an exit surface that are convex toward the image sensor (image plane).

The fifth lens V may have a positive (+) power, and according to an embodiment of the present disclosure, at least one of an incidence surface and an exit surface thereof may be an aspherical surface and the aspherical surface may have at least two inflection points.

The sixth lens VI may have a negative (−) power, and according to an embodiment of the present disclosure, at least one of an incidence surface and an exit surface thereof may be an aspherical surface and the aspherical surface may have at least two inflection points.

An iris diaphragm (stop) S1 and an infrared blocking unit IR may be further provided in the lens optical system of the present disclosure. The iris diaphragm S1 may be provided between the third lens III and the fourth lens IV. The infrared blocking unit IR may be provided between the sixth lens VI and the image sensor IMG.

The infrared blocking unit IR may be an infrared blocking filter. The positions of the iris diaphragm S1 and the infrared blocking unit IR may vary according to various embodiments.

The lens optical system having the above configuration according to embodiments of the present disclosure may satisfy at least one of the following Conditions 1 to 6.

70≤FOV≤90 <Condition 1>

Here, FOV (Field of view) denotes an angle of view in a diagonal direction of the optical system, and the unit thereof is degree. This is a condition for a high-resolution wide-angle design of the lens optical system of the present disclosure.

0.55≤TTL/IH≤0.8 <Condition 2>

Here, TTL (Total Track Length) denotes a distance or height from a center of the incidence surface of the first lens I to the image plane (or the image sensor), and IH denotes an effective diameter image height (image height).

This defines the total length of the optical lens system with respect to the sensor size, which is a condition for an ultra-slim design of a wide-angle lens that may be mounted on a mobile phone.

0.9≤Ind1/Ind2≤1.05 <Condition 3>

Here, Ind1 denotes a refractive index of the first lens I and Ind2 denotes a refractive index of the second lens II. This is a condition for minimizing chromatic aberration.

1.5≤Abv1/Abv2≤3.5 <Condition 4>

Here, Abv1 denotes an Abbe number of the first lens I and Abv2 denotes an Abbe number of the second lens II. This is a condition for minimizing chromatic aberration.

The chromatic aberration generated in a super-wide-angle lens may be minimized by arranging the Abbe number abv1 of the first lens I to be greater than the Abbe number abv2 of the second lens II.

0.9≤Ind6/Ind4≤1.05 <Condition 5>

Here, Ind6 denotes a refractive index of the sixth lens VI and Ind4 denotes a refractive index of the fourth lens IV.

1.5≤Abv6/Abv4≤3.5 <Condition 6>

Here, Abv6 denotes an Abbe number of the sixth lens VI and Abv4 denotes an Abbe number of the fourth lens IV.

The chromatic aberration generated in a super-wide-angle lens may be minimized by arranging the Abbe number of the sixth lens to be greater than the Abbe number of the fourth lens.

Table 1 below shows the optical characteristics of the first to third embodiments EMB1 to EMB3 illustrated in FIGS. 1 to 3.

TABLE 1

| Definition | EMB1 | EMB2 | EMB3 |
|---|---|---|---|
| Image Height(IH) | 8.30 | 6.96 | 6.34 |
| Total Track Length (TTL) | 5.26 | 4.92 | 4.70 |
| Overall Length (OAL) | 4.14 | 3.69 | 3.92 |
| Field of View (FOV) | 84.36 | 79.97 | 76.36 |
| Effective Focal Length (EFL) | 4.50 | 4.10 | 3.98 |
| Back Focal Length (BFL) | 1.12 | 1.23 | 0.78 |
| F Number (F no = EFL/EPD) | 2.09 | 2.28 | 1.90 |
| Refractive index of 1st lens (Ind1) | 1.543 | 1.543 | 1.543 |
| Refractive index of 2nd lens (Ind2) | 1.647 | 1.647 | 1.647 |
| Refractive index of 4th lens (Ind4) | 1.647 | 1.647 | 1.647 |
| Refractive index of 6th lens (Ind6) | 1.543 | 1.543 | 1.543 |
| Abbe number of 1st lens (Abv1) | 56.093 | 56.093 | 56.093 |
| Abbe number of 2nd lens (Abv2) | 21.474 | 21.474 | 21.474 |
| Abbe number of 4th lens (Abv4) | 21.474 | 21.474 | 21.474 |
| Abbe number of the 6th lens (Abv6) | 56.093 | 56.093 | 56.093 |

Herein, IH denotes an image height in an effective diameter, TTL denotes a distance from the center of the incidence surface of the first lens I to the sensor, and OAL denotes a distance from the center of the incidence surface of the first lens I to the center of the exit surface of the sixth lens, the unit of which is mm. Also, FOV denotes an angle of view (degree) of the optical system in the diagonal direction.

Table 2 below shows the results of comparing the optical conditions of the first to third embodiments of the present disclosure to the above Conditions 1 to 6.

TABLE 2

| Condition | Definition | EMB1 | EMB2 | EMB3 |
|---|---|---|---|---|
| 1 | 70 ≤ FOV ≤ 90 | 84.36 | 79.97 | 76.36 |
| 2 | 0.55 ≤ TTL/IH ≤ 0.8 | 0.63 | 0.71 | 0.74 |
| 3 | 0.9 ≤ Ind1/Ind2 ≤ 1.05 | 0.94 | 0.94 | 0.94 |
| 4 | 1.5 ≤ Abv1/Abv2 ≤ 3.5 | 2.61 | 2.61 | 2.61 |
| 5 | 0.9 ≤ Ind6/Ind4 ≤ 1.05 | 0.94 | 0.94 | 0.94 |
| 6 | 1.5 ≤ Abv6/Abv4 ≤ 3.5 | 2.61 | 2.61 | 2.61 |

Referring to Table 2, it may be seen that the lens optical systems of the first to third embodiments satisfy the Conditions 1 to 6. In the lens optical system having this configuration according to embodiments of the present disclosure, the first to sixth lenses I to VI may be made of plastic in consideration of the shapes and dimensions thereof and particularly the first lens having a large diameter may be made of plastic having a high refractive index.

Hereinafter, the first to third embodiments of the present disclosure will be described in detail with reference to the lens data and the accompanying drawings.

Tables 3 to 5 below show the curvature radius, the lens thickness or the distance between lenses, the refractive index, and the Abbe number of each lens constituting the lens optical systems of FIGS. 1 to 3, respectively.

In Tables 3 to 5, R denotes a curvature radius, D denotes a lens thickness or a lens interval or an interval between adjacent components, Nd denotes a refractive index of a lens measured by using a d-line, and Vd denotes an Abbe number of the lens with respect to the d-line. Herein, the unit of “R” value and “D” value is mm.

TABLE 3

| EMB1 | Surface | Radius | Thickness | Nd | Vd |
|---|---|---|---|---|---|
| | 1 | Infinity | 0.27852 | | |
| | Stop | Infinity | −0.27852 | | |
| I | 3 | 1.73587 | 0.73401 | 1.54410 | 56.09278 |
| | 4 | 9.19105 | 0.07617 | | |
| II | 5 | 4.10878 | 0.20142 | 1.65041 | 21.47439 |
| | 6 | 2.47212 | 0.31248 | | |
| III | 7 | 116.48534 | 0.40791 | 1.54410 | 56.09278 |
| | 8 | −9.06310 | 0.29568 | | |
| IV | 9 | −3.55645 | 0.22209 | 1.65041 | 21.47439 |
| | 10 | −8.15483 | 0.22448 | | |
| V | 11 | 3.58703 | 0.52557 | 1.65041 | 21.47439 |
| | 12 | 6.02938 | 0.38461 | | |
| VI | 13 | 2.62269 | 0.75072 | 1.54410 | 56.09278 |
| | 14 | 1.69904 | 0.29056 | | |

TABLE 4

| EMB2 | Surface | Radius | Thickness | Nd | Vd |
|---|---|---|---|---|---|
| | 1 | Infinity | 0.23964 | | |
| | Stop | Infinity | −0.23964 | | |
| I | 3 | 1.69309 | 0.75917 | 1.54410 | 56.09278 |
| | 4 | 21.17273 | 0.07441 | | |
| II | 5 | 4.57448 | 0.20000 | 1.65041 | 21.47439 |
| | 6 | 2.34313 | 0.27022 | | |
| III | 7 | 21.36291 | 0.36453 | 1.54410 | 56.09278 |
| | 8 | −9.38480 | 0.28589 | | |
| IV | 9 | −2.95699 | 0.35000 | 1.65041 | 21.47439 |
| | 10 | −5.34625 | 0.09024 | | |
| V | 11 | 4.94780 | 0.48607 | 1.65041 | 21.47439 |
| | 12 | 4.87111 | 0.21428 | | |
| VI | 13 | 1.43998 | 0.59445 | 1.54410 | 56.09278 |
| | 14 | 1.23409 | 0.25000 | | |

TABLE 5

| EMB3 | Surface | Radius | Thickness | Nd | Vd |
|---|---|---|---|---|---|
| | 1 | Infinity | 0.21961 | | |
| | Stop | Infinity | −0.21961 | | |
| | 3 | 1.48511 | 0.60454 | 1.54410 | 56.09278 |
| | 4 | 8.96437 | 0.10000 | | |
| | 5 | 3.64120 | 0.20066 | 1.65041 | 21.47439 |
| | 6 | 2.07011 | 0.40743 | | |
| | 7 | −61.17562 | 0.49349 | 1.54410 | 56.09278 |
| | 8 | −4.56083 | 0.10000 | | |
| | 9 | −3.96055 | 0.20000 | 1.65041 | 21.47439 |
| | 10 | −52.06148 | 0.28950 | | |
| | 11 | 2.48087 | 0.47722 | 1.65041 | 21.47439 |
| | 12 | 3.96723 | 0.33884 | | |
| | 13 | 4.23634 | 0.70520 | 1.54410 | 56.09278 |
| | 14 | 1.81202 | 0.40000 | | |

Meanwhile, in the lens optical systems according to the first to third embodiments of the present disclosure, all or some of the lenses may have aspherical surfaces. In the lens optical systems according to the first to third embodiments of the present disclosure, the aspherical surfaces may satisfy the following aspherical equation.

$$Z = \frac{{Y}^{2}}{R ( 1 + \sqrt{1 - ( 1 + K ) {Y}^{2} / {R}^{2}}} + {AY}^{4} + {BY}^{6} + {CY}^{8} + {DY}^{10} + {EY}^{12} + {FY}^{14} + {GY}^{16} + {HY}^{18} + {JY}^{20}$$

Here, “Z” denotes a distance from the vertex of each lens in the optical axis direction, “Y” denotes a distance in a direction perpendicular to the optical axis, “R” denotes a curvature radius in the vertex of the lens, “K” denotes a conic constant, and “A, B, C, D, E, F, G, H, and J” denote aspherical coefficients.

Tables 6 to 8 below show aspherical coefficients in the lens systems according to the first to third embodiments corresponding to FIGS. 1 to 3, respectively.

TABLE 6

| EMB | | | | | | | | | | |
|---|---|---|---|---|---|---|---|---|---|---|
| 1 | S | K | A | B | C | D | E | E | G | H |
| I | 3 | −0.44039 | 0.00616 | −0.00991 | 0.03727 | −0.09585 | 0.11343 | −0.06979 | 0.01620 | 0.00000 |
| | 4 | 0.00000 | −0.14392 | 0.23630 | −0.25118 | 0.10874 | 0.02070 | −0.04084 | 0.01178 | 0.00000 |
| II | 5 | −31.03542 | −0.15107 | 0.33802 | −0.22559 | −0.13994 | 0.39064 | −0.27670 | 0.07143 | 0.00000 |
| | 6 | 4.25463 | −0.13575 | 0.23004 | −0.20825 | 0.08667 | −0.05661 | 0.08461 | −0.04957 | 0.00000 |
| III | 7 | 0.00000 | −0.03636 | −0.02967 | 0.03802 | −0.04188 | 0.00000 | 0.00000 | 0.00000 | 0.00000 |
| | 8 | 0.00000 | −0.05482 | 0.08145 | −0.16584 | 0.12873 | −0.05420 | −0.00078 | 0.00327 | 0.00000 |
| IV | 9 | 5.60054 | −0.17145 | 0.48681 | −0.80931 | 0.86252 | −0.55966 | 0.20287 | −0.03320 | 0.00000 |
| | 10 | −28.61499 | −0.22633 | 0.34329 | −0.38877 | 0.26334 | −0.06939 | −0.01190 | 0.00990 | −0.00144 |
| V | 11 | 0.00000 | −0.05611 | −0.00061 | −0.01153 | 0.00480 | −0.00049 | 0.00000 | 0.00000 | 0.00000 |
| | 12 | −17.34419 | 0.00376 | −0.02395 | 0.00500 | −0.00036 | 0.00000 | 0.00000 | 0.00000 | 0.00000 |
| VI | 13 | −8.54652 | −0.13742 | 0.03038 | −0.00273 | 0.00011 | 0.00000 | 0.00000 | 0.00000 | 0.00000 |
| | 14 | −0.98155 | −0.17177 | 0.06435 | −0.02116 | 0.00467 | −0.00061 | 0.00004 | 0.00000 | 0.00000 |

TABLE 7

| EMB | | | | | | | | | | |
|---|---|---|---|---|---|---|---|---|---|---|
| 2 | S | K | A | B | C | D | E | F | G | H |
| I | 3 | −0.47996 | 0.00654 | −0.03912 | 0.13602 | −0.33994 | 0.44709 | −0.31110 | 0.08537 | 0.00000 |
| | 4 | 0.00000 | −0.15886 | 0.45059 | −0.99358 | 1.30402 | −0.95958 | 0.31707 | −0.03176 | 0.00000 |
| II | 5 | −25.76454 | −0.17849 | 0.60295 | −0.85153 | 0.37419 | 0.68687 | −0.89996 | 0.26106 | 0.00000 |
| | 6 | 4.39055 | −0.16785 | 0.38330 | −0.57934 | 0.47273 | −0.28289 | 0.34864 | −0.23162 | 0.00000 |
| III | 7 | 0.00000 | −0.13675 | 0.23018 | −0.93620 | 2.09301 | −2.72214 | 1.48538 | 0.00000 | 0.00000 |
| | 8 | 11.06267 | −0.17475 | 0.34770 | −0.90260 | 1.49423 | −1.51558 | 0.75153 | −0.10880 | 0.00000 |
| IV | 9 | 0.68561 | −0.28798 | 0.87494 | −1.64428 | 2.20411 | −1.83381 | 0.82529 | −0.15486 | 0.00000 |
| | 10 | −28.75063 | −0.34342 | 0.73748 | −1.17918 | 1.27222 | −0.81404 | 0.29725 | −0.05755 | 0.00459 |
| V | 11 | 0.00000 | 0.01372 | −0.07757 | 0.01183 | 0.00557 | −0.00118 | 0.00000 | 0.00000 | 0.00000 |
| | 12 | −17.01732 | 0.01891 | −0.04875 | 0.01372 | −0.00155 | 0.00006 | 0.00000 | 0.00000 | 0.00000 |
| VI | 13 | −4.54634 | −0.26830 | 0.08478 | −0.01222 | 0.00126 | −0.00013 | 0.00001 | 0.00000 | 0.00000 |
| | 14 | −1.00812 | −0.33475 | 0.17311 | −0.07441 | 0.02182 | −0.00388 | 0.00037 | −0.00001 | 0.00000 |

TABLE 8

| EMB | | | | | | | | | | |
|---|---|---|---|---|---|---|---|---|---|---|
| 3 | S | K | A | B | C | D | E | F | G | H |
| | 3 | −0.12540 | 0.00504 | 0.01868 | −0.07399 | 0.19113 | −0.28350 | 0.21634 | −0.07048 | 0.00000 |
| | 4 | 0.00000 | −0.09727 | 0.19566 | −0.27960 | 0.25579 | −0.14318 | 0.03570 | −0.00503 | 0.00000 |
| | 5 | −37.64718 | −0.11551 | 0.22802 | −0.07792 | −0.29524 | 0.62402 | −0.50679 | 0.15880 | 0.00000 |
| | 6 | 3.76345 | −0.19211 | 0.28937 | −0.50430 | 0.99835 | −1.70842 | 1.75049 | −0.77856 | 0.00000 |
| | 7 | 0.00000 | −0.07235 | 0.06903 | −0.42444 | 0.91872 | −1.00185 | 0.44662 | 0.00000 | 0.00000 |
| | 8 | 4.23146 | −0.11761 | 0.55141 | −1.42402 | 1.82777 | −1.22797 | 0.36708 | −0.02280 | 0.00000 |
| | 9 | 0.36255 | −0.26030 | 1.12134 | −2.55715 | 3.40251 | −2.59173 | 1.04881 | −0.17805 | 0.00000 |
| | 10 | −28.70630 | −0.27640 | 0.62470 | −1.06982 | 1.21496 | −0.81519 | 0.31223 | −0.06358 | 0.00536 |
| | 11 | 0.00000 | −0.10239 | 0.02087 | −0.02823 | 0.01140 | −0.00138 | 0.00000 | 0.00000 | 0.00000 |
| | 12 | −17.03189 | −0.00629 | −0.02658 | 0.00395 | 0.00055 | −0.00014 | 0.00000 | 0.00000 | 0.00000 |
| | 13 | −1.97292 | −0.24683 | 0.07884 | −0.00997 | 0.00043 | 0.00000 | 0.00000 | 0.00000 | 0.00000 |
| | 14 | −0.97037 | −0.20987 | 0.09481 | −0.03952 | 0.01150 | −0.00201 | 0.00019 | −0.00001 | 0.00000 |

As described above, the lens optical system according to the present disclosure may have a lens configuration of six groups of six lenses, a positive (+) power may be given to the first lens, the third lens, and the fifth lens, and a negative (−) power may be given to the second lens, the fourth lens, and the sixth lens. All the lenses may have an aspherical incidence surface or exit surface. Also, the aspherical surfaces of the fifth lens and the sixth lens may have at least two inflection points.

FIG. 4 is an aberration diagram illustrating longitudinal spherical aberration, astigmatic field curvature, and distortion of the lens optical system according to the first embodiment (FIG. 1) of the present disclosure, that is, the lens optical system having the numerical values of Table 3.

FIG. 4(a) illustrates spherical aberration of the lens optical system with respect to various wavelengths of light, and FIG. 4(b) illustrates astigmatic field curvature (i.e., tangential field curvature T and sagittal field curvature S) of the lens optical system.

Herein, light wavelengths 650.0000 nm, 610.0000 nm, 555.0000 nm, 510.0000 nm, and 470.0000 nm are used to obtain (a) data. A light wavelength 546.1000 nm is used to obtain (b) and (c) data. This is also true in FIGS. 5 and 6.

FIG. 5(a), FIG. 5(b), and FIG. 5(c) are respectively aberration diagrams illustrating longitudinal spherical aberration, astigmatic field curvature, and distortion of the lens optical system according to the second embodiment (FIG. 2) of the present disclosure, that is, the lens optical system having the numerical values of Table 4.

FIG. 6(a), FIG. 6(b), and FIG. 6(c) are respectively aberration diagrams illustrating longitudinal spherical aberration, astigmatic field curvature, and distortion of the lens optical system according to the third embodiment (FIG. 3) of the present disclosure, that is, the lens optical system having the numerical values of Table 5.

As described above, a lens optical system according to embodiments of the present disclosure may include first to fifth lenses I to VI that are sequentially arranged from an object OBJ to an image sensor IMG and have a positive (+) power, a negative (−) power, a positive (+) power, a negative (−) power, a positive (+) power, and a negative (−) power respectively, and may satisfy at least one of the above Conditions (1) to (6). The lens optical system may easily (well) correct various aberrations and may have a relatively short total length. Thus, according to an embodiment of the present disclosure, it may be possible to implement a lens optical system that is suitable particularly for a mobile phone and may obtain high performance and high resolution while being small in size.

All of the first to sixth lenses I to VI may be plastic lenses. In the case of glass lenses, it may be difficult to miniaturize the lens optical system due to the constraint conditions of molding/processing as well as high manufacturing cost. However, in the present disclosure, since all of the first to sixth lenses I to VI may be made of plastic, various advantages may be achieved accordingly.

However, in the present disclosure, the material of the first to sixth lenses I to VI is not limited to plastic. When necessary, at least one of the first to sixth lenses I to VI may be made of glass.

As described above, the fifth lens V may have a positive (+) power, the sixth lens VI may have a negative (−) power, and at least one of the fifth and sixth lenses V and VI may have an aspherical surface having two inflection points.

According to the present disclosure, since all the lenses may be made of plastic, a lens optical system that is compact and has excellent performance may be implemented at low cost in comparison with the case of using glass lenses.

According to the present disclosure, even in the case of lenses with high performance of 16 M or more incorporated in a mobile phone, a subminiature and ultra-slim lens optical system may be implemented. Particularly, a plastic aspherical material may be used for an ultra-slim optical system applied to a mobile phone, and it may be possible to achieve a design having low sensitivity while implementing high performance by power arrangement distribution according to suitable diaphragm position setting, and thus, mass production may be ensured. The lens optical system according to the present disclosure may also be applied to a high-resolution sensor of 20 M pixels or more.

Although many details have been described above, they are not intended to limit the scope of the present disclosure, but should be interpreted as examples of the embodiments. For example, those of ordinary skill in the art will understand that various additional elements may be used as the infrared blocking means IR in addition to the filter. It will also be understood that various other modifications are possible. Therefore, the scope of the present disclosure should be defined not by the described embodiments but by the technical spirit and scope described in the following claims.

What is claimed is:

1. A lens optical system comprising:
a first lens, a second lens, a third lens, a fourth lens, a fifth lens, and a sixth lens sequentially arranged in the stated order on an optical axis between an object and an image plane,
wherein the first lens, the third lens, and the fifth lens have a positive (+) power,
the second lens, the fourth lens, and the sixth lens have a negative (−) power, and
the lens optical system satisfies the following Condition 1:
70≤Fov≤90 <Condition 1>
where FOV (Field of view) denotes an angle of view of the lens optical system in a diagonal direction.

2. The lens optical system of claim 1, wherein the lens optical system satisfies the following Condition 2:
0.55≤TTL/IH≤0.8 <Condition 2>
where TTL (Total Track Length) denotes a height from the first lens to the image plane and IH (Image Height) denotes an image height in an effective diameter.

3. The lens optical system of claim 1, wherein the lens optical system satisfies the following Condition 3:
0.9≤Ind1/Ind2≤1.05 <Condition 3>
where Ind2 denotes a refractive index of the second lens and Ind1 denotes a refractive index of the first lens.

4. The lens optical system of claim 1, wherein the lens optical system satisfies the following Condition 4:
1.5≤Abv1/Abv2≤3.5 <Condition 4>
where Abv1 denotes an Abbe number of the first lens and Abv2 denotes an Abbe number of the second lens.

5. The lens optical system of claim 2, wherein the lens optical system further satisfies the following Condition 4:
1.5≤Abv1/Abv2≤3.5 <Condition 4>
where Abv1 denotes an Abbe number of the first lens and Abv2 denotes an Abbe number of the second lens.

6. The lens optical system of claim 3, wherein the lens optical system further satisfies the following Condition 4:
1.5≤Abv1/Abv2≤3.5 <Condition 4>
where Abv1 denotes an Abbe number of the first lens and Abv2 denotes an Abbe number of the second lens.

7. The lens optical system of claim 4, wherein the lens optical system further satisfies the following Condition 5:
0.9≤Ind6/Ind4≤1.05 <Condition 5>
where Ind6 denotes a refractive index of the sixth lens and Ind4 denotes a refractive index of the fourth lens.

8. The lens optical system of claim 5, wherein the lens optical system further satisfies the following Condition 5:
0.9≤Ind6/Ind4≤1.05 <Condition 5>
where Ind6 denotes a refractive index of the sixth lens and Ind4 denotes a refractive index of the fourth lens.

9. The lens optical system of claim 6, wherein the lens optical system further satisfies the following Condition 5:
0.9≤Ind6/Ind4≤1.05 <Condition 5>
where Ind6 denotes a refractive index of the sixth lens and Ind4 denotes a refractive index of the fourth lens.

10. The lens optical system of claim 6, wherein the lens optical system further satisfies the following Condition 6:
1.5≤Abv6/Abv4≤3.5 <Condition 6>
where Abv6 denotes an Abbe number of the sixth lens and Abv4 denotes an Abbe number of the fourth lens.

11. The lens optical system of claim 7, wherein the lens optical system further satisfies the following Condition 6:
1.5≤Abv6/Abv4≤3.5 <Condition 6>
where Abv6 denotes an Abbe number of the sixth lens and Abv4 denotes an Abbe number of the fourth lens.

12. The lens optical system of claim 8, wherein the lens optical system further satisfies the following Condition 6:
1.5≤Abv6/Abv4≤3.5 <Condition 6>
where Abv6 denotes an Abbe number of the sixth lens and Abv4 denotes an Abbe number of the fourth lens.

13. The lens optical system of claim 1, wherein the lens optical system satisfies the following Condition 6:
1.5≤Abv6/Abv4≤3.5 <Condition 6>
where Abv6 denotes an Abbe number of the sixth lens and Abv4 denotes an Abbe number of the fourth lens.

14. The lens optical system of claim 2, wherein the lens optical system further satisfies the following Condition 6:
1.5≤Abv6/Abv4≤3.5 <Condition 6>
where Abv6 denotes an Abbe number of the sixth lens and Abv4 denotes an Abbe number of the fourth lens.

15. The lens optical system of claim 3, wherein the lens optical system further satisfies the following Condition 6:
1.5≤Abv6/Abv4≤3.5 <Condition 6>
where Abv6 denotes an Abbe number of the sixth lens and Abv4 denotes an Abbe number of the fourth lens.

16. The lens optical system of claim 1, further comprising an iris diaphragm provided between an incidence surface and an exit surface of the first lens.

17. A lens optical system comprising:
a first lens, a second lens, a third lens, a fourth lens, a fifth lens, and a sixth lens sequentially arranged in the stated order on an optical axis between an object and an image plane, the first lens having a positive power and an incidence surface convex toward the object, the second lens having a negative power and a meniscus shape convex toward the object, the third lens having a positive power and a biconvex shape, the fourth lens having a negative power and a meniscus shape convex toward the image plane, the fifth lens having a positive power, and the sixth lens having a negative power; and
an iris diaphragm located between the incidence surface and an exit surface of the first lens,
wherein the lens optical system satisfies the following Condition 1:
70≤FOV≤90 <Condition 1>
where FOV (Field of view) denotes an angle of view of the lens optical system in a diagonal direction.

18. The lens optical system of claim 17, wherein at least one of the fifth lens and the sixth lens has an aspherical surface having at least two inflection points.

19. The lens optical system of claim 17, wherein the lens optical system further satisfies at least one of the following Conditions 2 to 6:
0.55≤TTL/IH≤0.8 <Condition 2>
where TTL (Total Track Length) denotes a distance or height from a center of the incidence surface of the first lens to the image plane, and IH (Image Height) denotes an image height in an effective diameter.
0.9≤Ind1/Ind2≤1.05 <Condition 3>
where Ind1 denotes a refractive index of the first lens and Ind2 denotes a refractive index of the second lens.
1.5≤Abv1/Abv2≤3.5 <Condition 4>
where Abv1 denotes an Abbe number of the first lens and Abv2 denotes an Abbe number of the second lens.
0.9≤Ind6/Ind4≤1.05 <Condition 5>
where Ind6 denotes a refractive index of the sixth lens and Ind4 denotes a refractive index of the fourth lens.
1.5≤Abv6/Abv4≤3.5 <Condition 6>
where Abv6 denotes an Abbe number of the sixth lens and Abv4 denotes an Abbe number of the fourth lens.

20. The lens optical system of claim 18, wherein the lens optical system further satisfies at least one of the following Conditions 2 to 6:
0.55≤TTL/IH≤0.8 <Condition 2>
where TTL (Total Track Length) denotes a distance or height from a center of the incidence surface of the first lens to the image plane, and IH (Image Height) denotes an image height in an effective diameter.
0.9≤Ind1/Ind2≤1.05 <Condition 3>
where Ind1 denotes a refractive index of the first lens and Ind2 denotes a refractive index of the second lens.
1.5≤Abv1/Abv2≤3.5 <Condition 4>
where Abv1 denotes an Abbe number of the first lens and Abv2 denotes an Abbe number of the second lens.
0.9≤Ind6/Ind4≤1.05 <Condition 5>
where Ind6 denotes a refractive index of the sixth lens and Ind4 denotes a refractive index of the fourth lens.
1.5≤Abv6/Abv4≤3.5 <Condition 6>
where Abv6 denotes an Abbe number of the sixth lens and Abv4 denotes an Abbe number of the fourth lens.
